(19) United States
(12) Patent Application Publication
(10) Pub. No.: US 2009/0083073 A1
(43) Pub. Date: Mar. 26, 2009

(54) Home Healthcare Documentation Clearing House

(76) Inventors: Jayesh Mehta, Chicago, IL (US); Seema Singhal, Chicago, IL (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 12/239,292

(22) Filed: Sep. 26, 2008

Related U.S. Application Data
(60) Provisional application No. 60/975,257, filed on Sep. 26, 2007.

(51) Int. Cl. G06Q 50/00

(52) U.S. Cl. 705/2

(57) ABSTRACT

A system and method for handling communications, including care plan oversight, between medical providers, home healthcare providers and others using a central clearing house to link the respective parties together.

### CROSS-REFERENCE TO RELATED APPLICATIONS

This application claims priority to U.S. Provisional Application Ser. No. 60/975,257 filed on Sep. 26, 2007. The provisional application is commonly owned and incorporated by reference herein as if fully set forth herein.

### FEDERALLY SPONSORED RESEARCH OR DEVELOPMENT

N/A

### FIELD OF THE INVENTION

The present system is directed to a system and method for handling communications, including care plan oversight, between medical care providers, home healthcare providers and others.

### DESCRIPTION OF THE PRIOR ART

Home healthcare services are widely used today by practicing physicians, such as MD's and DO's, and physician extenders such as physician assistants and nurse practitioners (collectively “providers”). The utilization of home healthcare services, usually covered by Medicare, Medicaid, and private insurance companies, is increasing because the cost of inpatient care, already very high, is increasing rapidly. On the other hand, home-based healthcare can be more cost-effective and save money. Additionally, such services are often more convenient for patients to avail themselves to than inpatient care.

As shown in FIG. 1, home healthcare service orders are usually conveyed verbally by the providers, the provider offices, or hospital discharge planners to the home healthcare agency (“HHA”). The transcribed orders and ongoing reports, called care plan oversight (“CPO”), are generally sent by the home healthcare agency by mail or fax to the overseeing providers for signature. These plans are signed by the provider, copied by the provider's office for billing purposes, and mailed or faxed back to the home healthcare agency.

Any given provider's office typically deals with a number of different HLAs, often based on insurance coverage and contracts, and patient preference or convenience. Similarly, each HHA deals with a large pool of providers and providers' offices.

Signed orders are needed on file at the home healthcare agency in a timely fashion for the home healthcare agency to stay in compliance of regulations and for billing purposes. In addition, copies of signed orders need to be retained, organized, and/or collated by the providers' offices for CPO billing purposes, records maintenance, tracking and follow-up. This involves transporting or transmitting substantial amounts of paper between the home healthcare agency and the providers. As a result, paperwork can be lost and misfiled, making the process very onerous for home healthcare agencies and providers. Only one physician can bill for supervising home health care for a given patient in a calendar month. Ensuring that this happens, under the current system, is difficult. Indeed, there are provider organizations that do not bill for home health supervision because of the complexity of the process.

A number of different home healthcare software options exist today covering home healthcare activities, such as ordering, pharmacy tracking, generating care plans, billing, etc. Almost all of these options allow a final care plan to be printed, which is sent to providers by mail or fax. Only a few of these options provide free web-based access to CPO's for providers. It is important to also recognize that there are many modes of delivery which are not integrated. As a result, each software package and home healthcare agency has its own mode and manner of sending CPO's to providers. Most are delivered on paper (by fax or mail; often by both creating duplication and presenting significant difficulties in reconciliation of orders).

In short, there are many aspects and components involved in the above system and there is a lack of unity and cohesiveness. Present procedures are cumbersome and simply uniform. There is a need to facilitate the transactions and communications described above.

### SUMMARY OF THE INVENTION

The present development involves a central, web-based clearing house for home healthcare-care plan oversight (“HHCPO” or “HHCPO.com”) and the documentation associated therewith. It provides a single, central location where providers can log-in and have access to their home healthcare CPO's, irrespective of the originating home healthcare agency, patient and payor. This clearing house can use present practices followed by home healthcare agencies) and will accept paper uploads, such as scanned documents, as well as electronic uploads from existing software.

It is also expected the proposed system will not compete with any existing software (i.e. no major upgrades or changes in practice needed for home healthcare agencies) but will accept paper uploads as scans as well as electronic uploads from existing software.

The system made in accordance with the present invention conceptually merges the following two completely unrelated systems: (a) A system similar to the Checkfree system which acts as an intermediary between companies and consumers for electronic bill payment, and (b) a system similar to the Konica-Minolta DocNet system which converts paper documents into electronic documents for filing within an organization.

Accordingly, one method of the present invention is for providing home healthcare to a patient. The method comprising the steps of: (1) providing a server in communication with a plurality of networks comprising a physician network, a home healthcare agency network and a hospital network; (2) serving unexecuted care plan oversight documents via the server between at least two of the physician, home healthcare agency and hospital networks; (3) receiving with the server executed care plan oversight documents from one of the plurality of networks; (4) using the server to associate executed and unexecuted care plan oversight documents and retaining the executed and unexecuted care plan documents according to a patient identifier on a database; (5) generating care plan oversight document templates and serving the templates to at least one of the plurality of networks; and (6) using the server to associate executed and unexecuted care plan oversight documents and retaining the executed and unexecuted care plan documents according to a provider identifier on a database.

Another method of the present invention comprises the steps of: (1) providing a server for facilitating transactions between a plurality of networks comprising physician network, a home healthcare agency network and a hospital network; (2) using the server to provide unexecuted care plan oversight documents to one of the plurality of networks; and (3) using the server to receive executed care plan oversight documents categorizing care plan oversight documents for download from the server to one of the plurality of networks.

Another method of the present invention is directed to a system for managing home healthcare administration comprising: (1) a physician network comprising a plurality of physicians; (2) a home healthcare agency network comprising a plurality of home healthcare agencies in the business of providing in-home healthcare to patients; (3) a central server in communication with the physician, hospital and home healthcare agency networks for coordinating communications and data transferred between the physician, hospital, and home healthcare agency networks, the central server serving web-pages carrying care plan oversight data shared between the physician, hospital and home healthcare agency networks; and (4) providing means for electronically approving electronic work orders for carrying home health related tasks for a home health patient.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a block diagram of the present system;

FIG. 2 is a block diagram of the system made in accordance with the teachings of the present invention;

FIG. 3 is a sample opening screen for a provider;

FIG. 4 is a sample screen for home healthcare providers CPO signatures;

FIG. 5 is a block diagram of an HHCPO website sitting on a server and in communication with a plurality of networks comprising at least a patient network, a hospital network, and practicing physician office network, and a home healthcare agency network; and

FIG. 6 is a schematic diagram of a plurality of networks in communication with a central server including the HHCPO website and network administration.

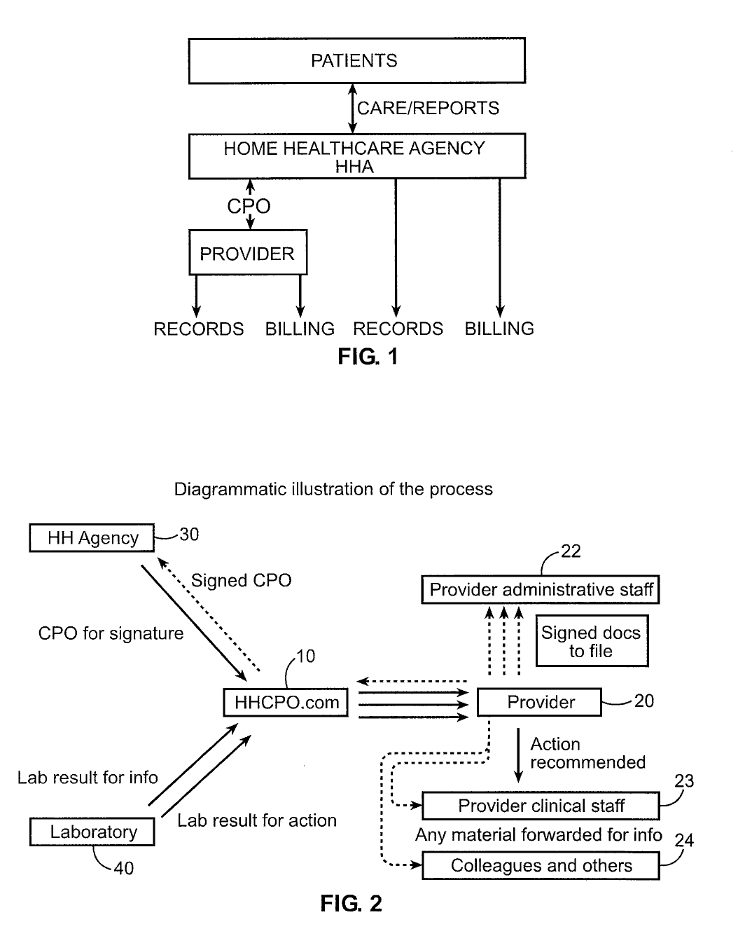

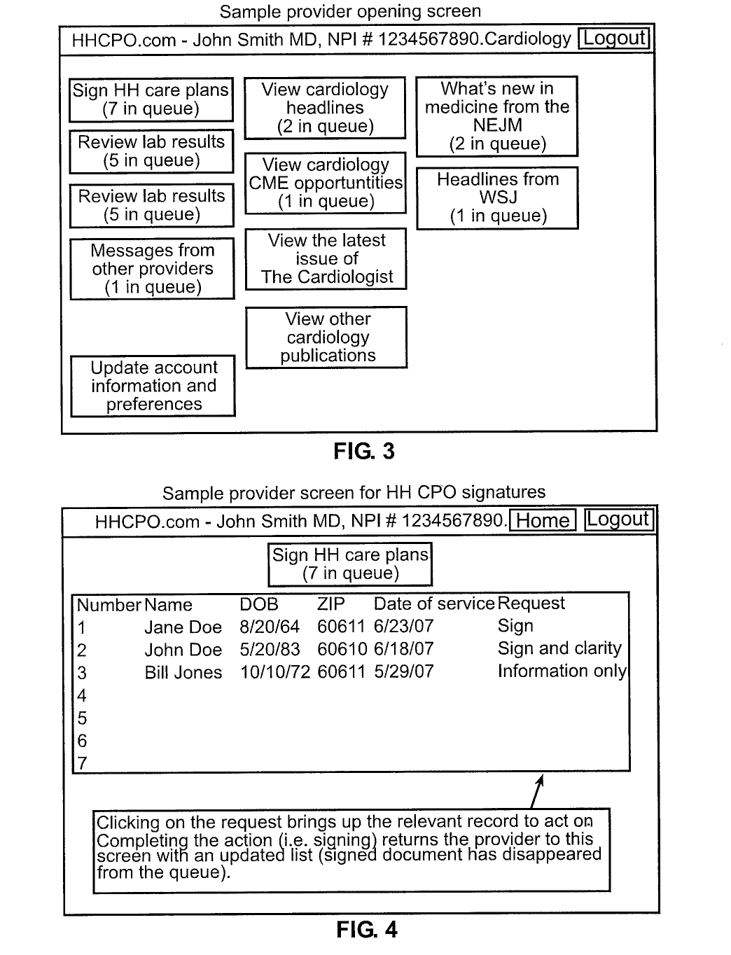

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

It should be understood that while the diagrams and discussion may show and talk about a single provider, laboratory or home healthcare agency, the discussion is meant to mean several. Accordingly, while one provider may be shown and discussed, the diagram and discussion necessary includes many.

As shown in FIG. 2, the system uses a central clearing house 10. Ideally, no physical or electronic records are retained in the clearing house. In alternative embodiments, the clearing house may be used as a depository of electronic files for long term, safe storage of electronic documents. The cleaning house's 10 primary purpose is to facilitate transactions between the several players. The clearing house acts as a liaison between the providers, home healthcare agencies, laboratories, and even insurance or billing agencies.

For example, transactions can be facilitated by having the provider 20 signing-on to the clearing house website 10 (e.g., HHCPO or HHCPO.com) and obtaining the documents for him/her to review and/or to execute. The documents are then kept in the clearing house until retrieved by others. This can be accomplished by several techniques. One way is to have the executed documents internally transferred in the clearing house from one location (e.g., provider's in-box) to another location (e.g., healthcare agency's inbox). Another is to have certain access codes to specific locations at the clearing house website. Specifically, others (home healthcare agencies, laboratories, and even insurance or billing agencies) can then obtain the executed documents or notes by signing on to the clearing house website 10 and retrieving the documents pursuant to a particular protocol. In the alternative, unsigned documents or documents containing information are transmitted from multiple, different originating sources to a provider 20 (via email). Documents signed by the provider are transmitted from the provider 20 (via email) to their destinations, usually the originating home healthcare agency 30 with copies to appropriate places, such as the provider's staff and colleagues (administrative staff 22, clinical staff 23, and colleagues 24). Signed documents can be manually or automatically deleted or stored from the inbox of the home healthcare agency 30 when they are printed or downloaded, or after a specified period of time if not printed or downloaded. Similarly, unsigned documents left in the inbox of a provider 20 (e.g., documents where no action has been taken by the provider) can be automatically returned via email to the home healthcare agency 30 after a specified period for appropriate follow-up by the home healthcare agency.

### Initial Procedure

Initially, home healthcare agencies register and pay for access to and use of the system, such as by (a) annual membership fee and a per transaction fee, (b) a per transaction fee only, or (c) an annual membership fee only. Individual employees with the home healthcare agencies also register. This is important to ensure the safe, secure and correct routing of documents. Per transaction fees can be volume-based with volume discounts. Similarly, home healthcare agencies signing on for the service early may be offered better prices—which will likely increase as the system gains popularity and work volume increases. This volume-based charge structure is beneficial to home healthcare agencies as there is no large upfront cost.

It is envisioned that providers will register and use the system free. Registration information includes legal name, mailing address, state license number, UPIN number, National Provider Identifier (NPI), and DEA number. Such providers may also have the option to log-on to clearing house website 10 (HHCPO.com) on a regular basis (as they desire) or to have automatic emails sent to them with a log-on link when there is a CPO waiting to be signed by them.

In all of the above, user names and passwords are created or generated at the time of registration.

Home healthcare agencies can upload paper documents, such as CPO's, via scanners or via software packages containing fill-in templates. Either can be used and sent to the clearing house 10. It is recognized that the clearing house 10 can develop CPO templates which can be used by home healthcare agencies just for this purpose. There would likely be an additional fee for developing or using these templates. One advantage of using the clearing house's templates is that incorporating standard information in a standardized format gives one many options, such as grabbing and using such information for other purposes, e.g., record keeping, billing, follow-up, etc. Standardized information would necessarily be comprehensive. If a paper CPO is uploaded by scanner, digital attributes will need to be assigned. It may be possible to extract digital attribute information if the CPO is sent electronically to the clearing house from a software package.

### System Procedures

When a provider 20 logs-on to the system, s/he is provided with a series of CPO's to sign electronically that are in his/her inbox. It is recognized that all inboxes in the system have respective outboxes. By the provider's signing a CPO, it automatically transfers the signed documents to the provider's outbox. The default envisioned is that by signing a document, it automatically generates the date, proper authentication and approval necessary for transmitting and authenticating the document. This can be accomplished by known techniques using a single click. For CPO's developed by the clearing house 10, the signature automatically gets affixed to the appropriate place. For other CPO's, clicking at any place on the document affixes the digital signatures at that place. The whole process is basically seamless and easy so that the provider can concentrate on the patient and the treatment rather than getting encumbered by sheets of paper that distract from medical care and waste time.

The appearance of the signature would be along the following lines:

Reviewed, approved and digitally signed by:

John Smith MD on 23 Jun. 2007, 9.37 AM CST

NPI # XXXXXXXXXX

Most home healthcare CPO's need only a signature and a date. Some CPO's need clarification or comments. If the CPO is uploaded with a comment and a question, it can be flagged to alert the provider 10 of the comment/question. If the CPO requires only a signature, a flag would be unnecessary. If there is a comment/clarification flag, the system defaults with the first click to generate a free text field for the provider 10 to create a reply or specific clarification; a second click closes the field and the CPO is signed as above. The text box should automatically adjust to be within the size of the document margins.

The system can be set-up so that a CPO not flagged for comment wherein the default with a single-click is authentication, it will be possible for the provider to select a comment option—in which case the action sequence will be as outlined above (click-type-click). The comment field selected by the provider 20 can be (a) a general comment, (b) an instruction for provider's office/clinical staff/etc. 22,23,24, or (c) an instruction to the home healthcare agency 30. Whenever such a field is created, the document is flagged during the signing process so that upon receipt by another party (the provider's administrative staff and/or the home healthcare agency), there is an alert or notice that there is a comment/instruction present in the transmitted document.

A CPO signed by the provider is sent back to the originating home healthcare agency 30, specifically the person associated with the home healthcare agency originating the plan and/or others in the agency, such as billing/records/compliance personnel or individuals supervising or also involved with the patient and provider. The signed CPO can then be printed and filed, or filed electronically within the home healthcare agency's own computer system 30. By printing or electronically filing the CPO duplication of action can be minimized or avoided. The system can be set-up so as to delete executed CPO's in the email system of the home healthcare agency after preset specific period of time, such as a week. CPO's not timely stored and filed can also be deleted automatically after a preset period of time, such as a month.

A signed care plan can be printed or digitally saved (electronically filed) by the provider's office for billing and record purposes.

Each provider log-on can have 2 passwords; one log-on allows the provider to log into the provider's inbox and to give that specific provider signing privileges; and, the other log-on grants an administrative person access only to the signed plans and print them. A group of provider accounts (i.e. a single practice) can be linked to a single administrative log-on so that all CPO's from a single practice can be accessed and dealt with simultaneously.

It should be noted that CPO's are often accompanied by lab results. Sometimes home healthcare agencies fax lab results for information without CPO's. These are sent to providers for information. They are flagged as results by the home healthcare agency so that their authentication does not result in their being returned to the home healthcare agency. Signing reviewed lab results is standard practice to documents reviewed and where action has been taken if needed. When a lab result flagged so comes to the provider, a single click results in approval (default) as follows:

Reviewed and digitally signed by:

John Smith MD on 23 Jun. 2007, 9.37 AM CST

NPI # XXXXXXXXXX

Place in patient file.

If a lab result generated by a lab 40 requires action, a provider can choose a different action whereby the first click opens a text box where instructions can be typed and the second click closes the text box and signs the document as above. Choosing the non-default option adds a flag to the document so that the provider's office staff and/or the home healthcare agency staff is alerted that action has been recommended.

The default upload from a home healthcare agency is to return the signed document to it once the provider signs the CPO. As with test results above, a discharge summary from the home healthcare agency or another notification can be flagged so that it simply goes to the provider's administrative account once signed—instead of being returned to the home healthcare agency.

The above system has many benefits to the home healthcare agencies. These include:

A much greater proportion of orders/records completed (signed) in time.

A greater regulatory compliance.

No need to fax and re-fax.

Avoidance of duplication—quick and accurate update on what has been sent and received back.

It is much easier reconciliation of records.

It saves costs in terms of manpower, paperwork, secretarial work, paper, and fax costs—likely resulting in no overall increase in cost from fees paid to clearing house.

Such benefits and convenience for the home healthcare agencies are likely to be such that they will encourage providers to register and use the service.

The above system also has many benefits to the providers. These include:

The ability to review and sign electronically—any time and from anywhere.

Avoidance of repetitive signatures—a bane at the moment.

It is easier and more complete billing for CPO.

The avoidance of illegible paperwork and the need for repeated photocopying/faxing.

Cost savings in terms of paper use, copying, faxing, secretarial time.

HIPAA compliance.

Joint Commission Accreditation of Healthcare Organizations (“JCAHO”) compliance.

The benefits and convenience are likely to be such that they will strongly recommend using the service to home healthcare agencies they deal with.

In addition, it should be noted there is presently no single common website for all US-based providers. The American Medical Association (AMA) does not include non-physician medical personnel (such as APNs, nurse practitioners, and physician assistants)—and not all physicians belong to the AMA.

Once launched as a CPO business, it is possible for this system to become the single largest collection of medical providers on the web. This large-volume audience can be used very effectively to improve medical care and education, advertising, sales, etc—and can potentially become far more valuable than the home health CPO business. Indeed, a virtual desktop for providers, wherein a provider logs-on to the system to manage almost all of his/her computer-based activities. Comprehensive electronic medical record (EMR) software packages such as Epic or Powerchart can further provide links to the clearing house (HHCPO.com) to facilitate the provider's ability to deal with all tasks from one site.

The system can also be used for home health nurses to send photographic records (for example a picture of a skin rash a patient may have) to the providers for their review.

The system can also have home health patients or their advocates register so they can be part of some of the communication between providers—particularly those relating to starting new services, stopping services, or altering their frequency.

Other advantages include targeted advertising: When providers log-on, they can be presented targeted ads in side bars. These ads can be based on specialty, geographic location, and interests indicated by the provider. These could be Continuing Medical Education (CME) opportunities, job opportunities, journals, other medical literature, pharmaceutical ads, other ads (e.g. financial services), and so on. This would be pay-per-click and/or pay-per-view and/or a set amount of money. This model can start generating revenues even before the Home healthcare agency volumes start increasing sufficiently—as providers register. Electronic versions (such as portable document format files—PDF's) of critical papers could be delivered using this medium.

There is no standard, assured method of communicating drug safety information to health care providers in the US. This can be the single medium for drug warnings originating from the Food and Drugs Administration (FDA), FDA-mandated “Dear Doctor” letters originating from pharmaceutical companies, other FDA notices, and so on.

Additionally, providers will be able to sign up for breaking medical/health news and research which can be emailed to them, or can be presented to them in another area of the website as a link on the main page. Non-medical news headlines can also be delivered if providers so choose. Publications such as Wall Street Journal may want to avail of this service—and would pay a defined sum of money per year for the ability to send a certain volume of information (e.g. $ xxx for one headline per day delivered to all providers).

Data gathering on home healthcare utilization by provider, practice, geographic area, agency, patient, and so on can be gathered. This information would be valuable in analyzing utilization patterns and trends, especially in conjunction with the provider's indicated specialty.

Other entities who may benefit from using this system include Labcorp, Quest and other large labs so as to be able to send results to providers using the system. A number of these laboratories already have their own systems, but from the provider's perspective, multiple log-ins are avoided. Providers often need to share these results with other providers. They have the ability to forward these to 2-3 other providers through the system. They can find other providers by first/last name, and city, state, or ZIP.

Similarly, Walgreen's, CVS, Wal-Mart, Target, and other pharmacies can benefit by sending prescription refill requests through this system. Providers can assign proxies for prescription refills—whereby a prescription routed to a physician can be sent to a nurse, PA, APN or secretary for refill (authentication on behalf of the provider) or for verification (to be re-routed back to the provider after verification). This individual would be registered as a provider or as an administrative assistant.

One or more message boards and/or chat rooms/forums can further be added to the system for discussions. An ability to forward information to or communicate with other providers on the system through HIPAA/secure lines, including patient referrals and transmission of patient information, can be very helpful.

Integration with clinical research—Clinical Research Office (CRO) back office operations—and digital signature on clinical trial documentation may be used in the system. This may not be applicable to places with on-site CRO's and Clinical Research Associates (CRA's)—but would be most useful for providers who do not have these facilities.

Drug preauthorization requests from pharmacy providers such as Medco etc can also be routed through this system.

The system can further be used for provider-to-provider communication of referred patients—instead of faxes.

The system can be further expanded to include patient-to-provider communication to provide a billable record. Patients pay to be registered. This could apply to communication between patients and providers where a professional relationship exists—and also to virtual consulting relationships where payments could be facilitated for a percent cut of the fees.

Each specialty has its own free professional publications which are mailed in bulk to physicians/providers in that specialty. For example, there are about a dozen publications mailed to physicians in the hematology-oncology field alone. This is very expensive. Providers can select 1-2 areas of interest at the time of registration (can be updated any time they want) and complimentary professional publications pertaining to that specialty could be delivered as links to PDF's using this system.

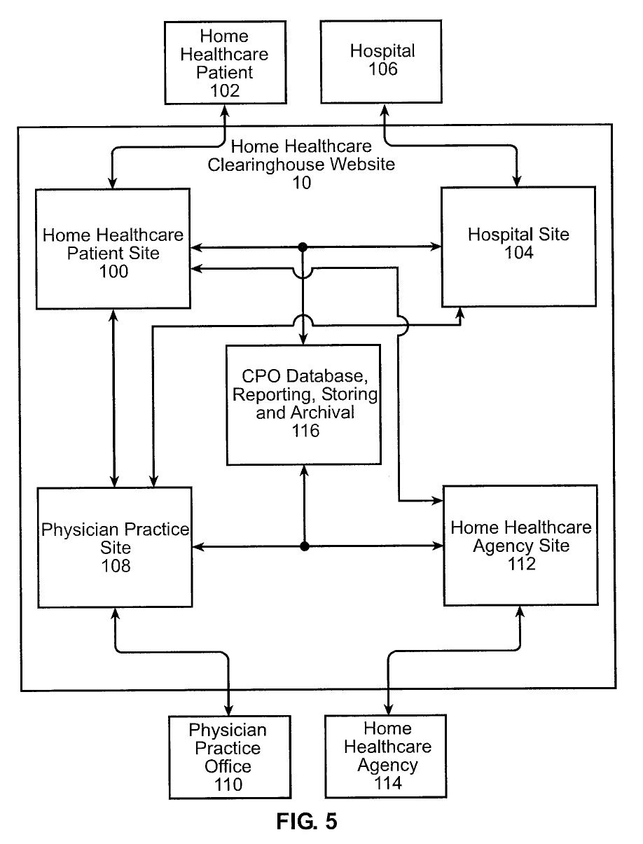

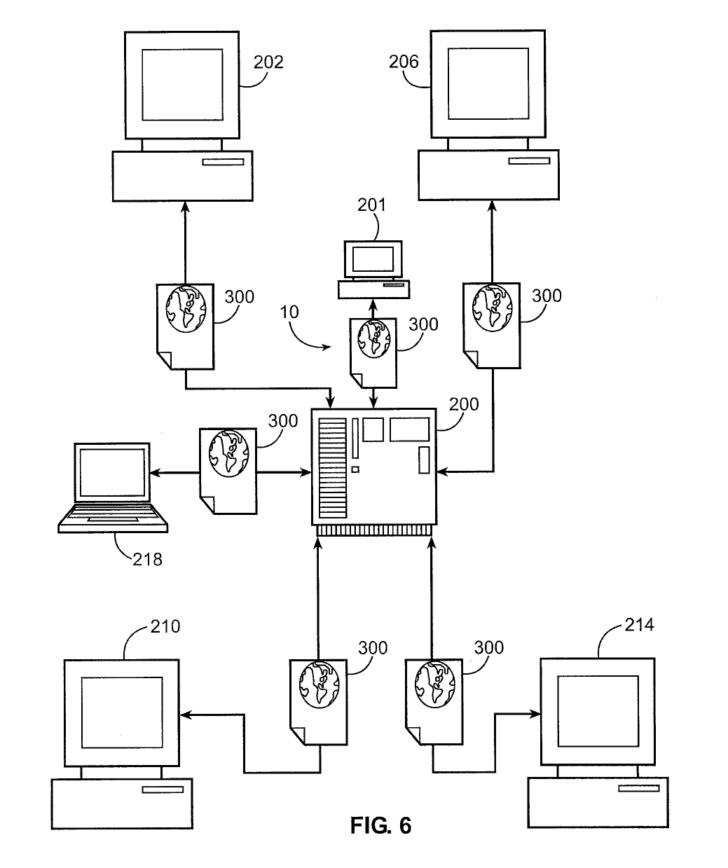

With reference to the FIGS., and more particularly to FIGS. 5 and 6, the HHCPO system will be described in detail.

### Registration Process Information

The registration module is a key component of the HHCPO system. Users can be invited to register or can choose to register directly from the home page. The registration process is not automatic. All new users must be approved by a HHCPO registration administrator before they can begin to use the system. Users will be assigned to a particular user category which will determine how they will use the system. The valid categories of users along with a list of potential registration data is provided below.

The registration process is as follows: (1) a potential new user from one of the valid user categories would be invited to register or would choose to register from the website. The new user would be asked to complete the appropriate registration information online; (2) the registration request would be forwarded to the HHCPO Registration Administrator who would validate that all necessary information has been entered. If additional information is needed, the administrator would contact the new user to get the necessary information; (3) after all information has been acquired and verified, the HHCPO administrator would assign a unique “USER ID” and temporary “PASSWORD” to the new user and a verification email message would be sent to the new user; and (4) the user must verify his email address and is then able to logon and begin to use the system. The user will be able to change his password online and will also be able to modify and maintain his account information online.

A software module supports the registration process. This module is accessible by the HHCPO registration administrator to facilitate the process of verifying and registering a new user. Some of the functionality includes: access a new user record to review and/or modify fields, generate new unique USER ID and temporary PASSWORD, generate a verification email message and some way to automatically activate the user after the user responds to the email message, and update or de-activate user records.

Physicians provide first name or initial, middle initial or name, last name (exactly as desired on digital document and as on the NPI), MD/DO, DEA number, state license number, UPIN number, NPI.

APN's provide first name or initial, middle initial name or name, last name (exactly as desired on digital document—and as on the NPI), degree, DEA number, state license number, UPIN number, NPI.

PA's provide first name or initial, middle initial or name, last name (exactly as wanted on digital document—and as on the NPI), degree, DEA number, state license number, UPIN number, NPI.

Note: The UPIN number may not be necessary; one may be able to use the NPI number instead.

Providers can also select different practice/specialty areas that can be used to provide them customized information.

Hospital discharge planners register by name, and employing hospital. They will initiate the process of starting home care under many circumstances.

Home healthcare agency selects provider name from a list, patient name from a list (or creates a new patient record using name, date of birth (DOB) and ZIP code—which is specific only to that agency), the number of pages, date of service, requested action (the default is sign only; alternatives include clarify and sign, FYI), and priority (the default is routine; alternatives include urgent, repeat, urgent repeat)—and hits send.

### HHCPO Site Categories

As shown in FIG. 5, the four (4) types of sites residing at HHCPO 10 and supported for HHCPO 10 are: (1) a home health patient site 100 for patients 102; (2) a hospital site 104 for hospital personnel; (3) a physician practice office site 108 for private practice MDs 110; and (4) a home health agency sites 112 for HHAs 114. The valid user categories associated with each site are described in the following in detail below.

As shown in FIG. 6, a plurality of networks (comprising any number of users) are in communication with a central server 200 which is home to the HHCPO website 10, and an HHCPO network administration 201. Preferably, the plurality of networks include a patient network 202, a hospital network 206, a physician practice network 210, and a home healthcare agency network 214. A single network is shown in the drawing, but the invention clearly contemplates multiple networks of each of these types to form the overall system described herein. Furthermore, mobile networks 218, such as using a laptop in a remote location, can be used to communicate with the central server 200. This would describe an MD or PA using a laptop from a home visit to a patient to communicate with the central server 200. The various networks download/upload data, including web pages and/or documents 300, to the server 200 as described in more detail below.

The following types of users will need to be supported at a particular hospital 106. An SA (HHCPO site administrator) is an administrator for the hospital site 104. The SA is able to create new users and administer existing users. There could be multiple hospital discharge planners (“HDP”) for one hospital 106. Multiple MDs might be associated with a particular hospital 106, but they may have their primary registration tied to a practice office 110. physician assistants and nurse practitioners (“PA”) might be associated with a particular hospital and/or MD at a hospital. There could be multiple compliance/billing administrators (“CBA”) associated with one hospital 106. CBAs are typically only responsible for billing compliance auditing. They will not be able to modify any electronic documents. They will strictly have access to the data for their hospital for review and reporting only.

The following types of users are supported at a particular MD practice site 108. A HHCPO site administrator is the administrator for the practice site 108. Eventually, they should be able to create new users and administer existing users. The MD may also be associated with a particular hospital 106. The MD has ONE primary site. The primary site will either be a practicing office 110 with multiple affiliations with hospitals, or the primary site will be a hospital 106. Multiple PAs might be associated with a particular practice and/or MD at a practice. There may be more than one CBA at a MD office 110. Again, the CBAs will only have access to the electronic files for review, reporting and billing.

The following types of users are supported at a particular home health agency site 112. A HHCPO site administrator is the administrator for the HHA 114. Eventually, they should be able to create new users and administer existing users. A HHA case administrator (“HCA”) is responsible for managing all of the cases and nurses. Home health nurses are the nurses that actually visit the patients in the home. There may be more than one CBA at a HHA 114. They will only have access to the electronic files for review, reporting and billing.

The following types of users will need to be supported at a patient home site 100. The actual patient will be able to access the site to retrieve and/or provide information from/to other users. A home health patient advocate, who is an approved advocate for the patient, will also be able to access the site 100.

### User Data Fields

The system uses several data fields from several different sources. For instance, the general site includes HHCPO registration information such as identifying information, a list of affiliated hospitals, a list of affiliated MDs, and a list of affiliated HHAs. The HHA includes a list of affiliated hospitals and a list of affiliated MDs. The hospital site includes a list of affiliated HHAs and a list of affiliated MDs. The MD practice site includes a list of affiliated HHAs and a list of affiliated hospitals.

Attributes of Each Document sent for Signature

Home Healthcare agency (name)

Provider (name, NPI)

Patient identifier (name, DOB, ZIP)

Number of pages

Date of service

Priority flag

The above enables the documents to be tracked for billing by the provider's office.

### Properties of Documents and Software

The document size should be as small as possible (for example, documents scanned as PDF's or JPG's, whatever is smaller) to facilitate fast loading over the internet. However, they should be completely legible.

When the provider logs in and is at the opening screen, items to be viewed start getting loaded in the cache or temporary files so that the process remains as fast as possible. Plans for signatures, results for review, and other action items are the first to get loaded. Other things on the opening screen continue to get loaded afterwards and the process of loading continues even when CPO's are being reviewed and signed so that whenever a link is clicked, the response is as fast as possible. Files are deleted when provider signs out.

Selecting the number of pages “stitches” the pages together into a single identifiable document, which is then signed by the provider in a single or multiple places. The document does not move into the outbox of the provider until every page has been reviewed on the screen.

The date of service assigned by the home healthcare agency is different from the date the document is sent for signature. This date is critical for billing because, for billing, a month's worth of home healthcare services are to be lumped together. The assignment of a digital date to a document facilitates automatic collation of signed orders for billing by patient-month in the provider office.

After filling in the information on the opening screen, hitting the send button scans the relevant documents. As soon as scanning is complete, the screen is ready for the next CPO. The upload to the clearing house (HHCPO.com) by FTP occurs in the background. Going to the Outbox provides information on scanned jobs and whether they have been successfully uploaded or not.

Special hardware (high-speed scanner) and software installation is required at the home healthcare agency (upload) end. No special software or hardware required at provider end. Specifically, the entire process can be done through web access.

### Workflow System

The workflow system is the core module for the HHCPO service website 10. The workflow system determines how each category of user is allowed to interact with other users and process CPOs.

Again, the CPO (work order) is the key document that drives the workflow process. A small set of standard electronic forms cover all CPO processes required to support the workflow system. The forms satisfy all HHA, MD and government requirements and simplify processing and billing requirements. The documents can be tracked for billing by the HHA and MD.

The HHCPO system 10 maintains a detailed history of all changes/modifications to any particular CPO in a database 116. The tracking system includes: the user ID of the user that made the change, the description of the type of change, a time stamp of when the change was made, and a list of users that received the modified CPO.

CPO documents have a limited number of valid conditions. These conditions are: (1) open, (2) assigned, (3) approved, (4) closed, (5) billed, and (6) paid.

Open conditions occur when a CPO is in the process of being created but has not been completed. This condition may occur to an MD, HHA, HHN, or HDP creating a CPO. Any open CPO cannot be sent to another user in the system.

Assigned conditions occur when a completed CPO is waiting on approval. For instance, an assigned-MD CPO occurs when the CPO has been assigned to the MD and is waiting approval; an assigned-HHA condition occurs when the CPO has been assigned to the HHA and is waiting approval; an assigned-HHN condition occurs when the CPO has been assigned to the HHN and is waiting approval; and so on.

The CPO enters an approved condition when the party on which approval was waiting has approved the CPO. For example, an approved-MD condition occurs after the CPO has been approved by the MD.

The CPO enters a closed condition when a user closes the document, and it is no longer available for modifications and/or comments. For example, a closed-MD condition arises when the CPO has been closed by the MD; a closed-HHA condition arises when the CPO has been closed by the HHA; and so on.

A billed condition occurs when the CPO has been submitted for payment, for example, a billed-CBA condition.

A paid-CBA condition occurs when payment has been received, and the CPO is moved to the archives

### User Functionality

Workflow is centered about a particular user's home page. Users have an option to log on to HHCPO.com 10 on a regular basis (as they want) or having an automatic email sent to them with a log-on link when there is a CPO waiting to be signed.

All users have access to a messaging module. The basic messaging system is provided to allow for user-to-user communication of referred patients—instead of faxes, this system could be used. The messaging system will provide the ability to send information to or communicate with other users on the system through HIPAA/secure lines—including referrals and patient information. The messaging system supports the following (at a minimum): create new messages, send a message to another user on the system, sort the list of messages, delete a message, respond to a message, flag a message as urgent. This module includes generation of a “Message Box” which is displayed on the user home page but will be separate from the user's “Inbox” for processing CPO items.

Each different type of user has a different level of access to the functionality of the HHCPO system depending on needs, responsibilities, requirements, federal regulations, etc.

For instance, the site administrator (SA) for any HHCPO site will have access to the following functionality: registering new users, configuring existing users, delete existing users, modifying existing users, resetting user passwords, modifying contact information, and modifying how individual CPO authentication is handled (i.e. modify defaults).

The compliance/billing administrators (CBA) for any HHCPO site have access to a different set of functionalities than the SAs. The CBAs have access to CPO reporting and a complete CPO transaction archive for all users at the site. All CPOs that are associated with all users and have been completed, approved and/or closed are saved in a workflow archive for each user. Archive reports are provided to allow the CBA to generate a summary of all CPO transaction history. The most critical reason behind this collation is to allow a summary of transactions by patient name, MD/PA name, and month in order to facilitate billing by month. The CBAs are able to print a hard-copy of any CPO in the archive. The archive contains all pertinent information associated with each CPO. The CBAs are also able to access a simple messaging system that supports communication between users in the system.

The hospital discharge planners (HDP) for any HHCPO hospital site have yet a different set of functionalities. The HDPs have access to a CPO Mail Box module. The CPO Mail Box module includes a CPO Inbox contains all CPOs that are awaiting action. A CPO is typically sent to a user from other users in the system and requires some action on the current user's part to continue the processing for the CPO. The Inbox supports some or all of the following actions depending on the category of user: creating CPOs (by clicking on the create button, the user can create a new electronic CPO from one of the possible CPO templates, or can upload a new digitally scanned CPO), editing CPOs (a CPO must be in one of the valid open states to be edited), assigning CPOs (once the HDP has successfully created the CPO, the HDP can assign the CPO to a MD or HHA for approval), and commenting on CPOs (most HDP CPOs are assigned to either a MD or a HHA, and some may need clarification or comments). The HDPs also have access to a CPO reporting module wherein the HDP has access to a complete CPO transaction archive for all CPO's it has been involved with. All CPOs that are associated with the HDP and have been completed, approved and/or closed are saved in a workflow archive for the HDP. Archive reports are provided to allow the HDP to generate a summary of all CPO transaction history. The HDP will be able to print a hard-copy of any CPO in the archive. The archive contains all pertinent information associated with each CPO including: electronic data comprising the CPO or a digital image representing the scanned CPO, date related information, and comment related information for each attached comment.

Physicians (MD) for any HHCPO hospital or physician practice site have access to the CPO Mail Box module. In addition to the create, edit, and assign functions, the MDs can approve, reject, and comment on a CPO. When physicians log on, they are provided a series of CPOs to electronically sign in the Inbox. Signing CPOs automatically transfers the documents back to other appropriate users in the system. The default is to sign/date/authenticate/approve using a single click. For CPOs developed by HHCPO.com, the signature automatically gets affixed to appropriate place. For scanned CPOs, clicking at any place on the document affixes the digital signatures to the document.

The MDs can also reject a CPO. If the MD chooses to reject a CPO, it is returned to the user that submitted it for approval. The user who submitted the CPO can edit it and resubmit the CPO to the MD. If rejected, the MD will be forced to add a “Rejection Comment” to the CPO to clarify why the CPO was rejected.

The MDs can also comment on a CPO. Most CPOs need only a signature and a date. Some need clarification or comments. If the CPO is uploaded with a comment and a question, it is flagged for the MD. If it is for a simple signature, there is no flag. If there is a comment/clarification flag, the default is for the first click to generate a free text field for the MD to type a reply or clarification—and then for a second click to close the field and sign as above. For a CPO that is not flagged for comment, and the default is for single-click authentication, it is possible for the MD to select a comment option—in which case the action sequence will be as outlined above (click-type-click). The comment field selected by the MD can be (a) a general comment, (b) an instruction for MD's office/clinical staff, or (c) an instruction to HHA. Whenever such a field is created, the document is flagged during the signing process so that on reaching the appropriate Inbox (the MD's administrative staff and/or for the HHA), there is a warning that there is a comment/instruction.

MDs also have access to a complete CPO transaction archive for all CPOs she/he has been involved with. In practice, it is going to be the billing/compliance people associated with the MD's office that will use the archives All CPOs that are associated with the MD and have been completed, approved, and/or closed are saved in a workflow archive for the MD on the database 116. Archive reports will be provided to allow the MD to generate a summary of all CPO transaction history. The MD will be able to print a hard-copy of any CPO in the archive. The archive contains all pertinent information associated with each CPO.

The physician assistant (PA) has access to some or all of the functionality available to the MD. When a PA user is created, the site administrator (SA) will be able to selectively add or remove functionality for any particular PA. A PA is generally associated with 1 or more MDs.

Each home health case administrator (HCA) for any HHCPO home health agency will have access to the CPO mail box, create CPO, and CPO reporting modules. In addition, the HCA modify its account configurations, such as modify passwords and contact information.

The home health nurse (HHN) for any HHCPO home health agency has access to the CPO Mail Box and CPO Reporting modules.

Home health patients (HHP) differ somewhat from other users. The HHPs may choose to receive copies of communications, such as CPOs relevant to their care. However, all communications may not be pertinent—and only those that involve starting, stopping, changing visit frequencies, etc. are relevant and need to be sent.

The home health patient advocate (HHPA) will have access to some or all of the functionality available to the HHP. The functionality available to the HHPA is determined and configured when the user is created.

### PRACTICAL EXAMPLE

Initial registration is processed through HHCPO 10. Users can be invited to register or can choose to register directly from the home page. The registration process is not automatic. All new users must be approved by the HHCPO registration administrator before they can begin to use the system. Users are assigned to particular user category which will determine how they will use the system.

Typically, a hospital is contacted and asked to register. The HHCPO registration administrator (HRA) contacts the site and collects the appropriate information for all possible user categories: site administrator (SA) (only one (1) SA per hospital site), hospital discharge planners (HDP) (one or more HDP per hospital site), attending physicians (MD) (one or more MD per hospital site), and compliance/billing administrator (CBA) (one or more CBA per hospital site. A confirmation, such as an email, is sent to each registered user for the site. Each user must respond to the confirmation email to finalize the registration process. This is used to confirm correct email address.

Typically, a physician practice is also contacted by the HRA and is asked to register. The HHCPO registration administrator (HRA) contacts the site and collects the appropriate information for all possible user categories: one site administrator, practicing physicians, physician assistants and nurse practitioners, and compliance/billing administrators. The confirmation process is followed as previously explained.

Similarly, a home health agency is contacted by the HRA and is asked to register. The HRA contacts the HHA and collects the appropriate information for all possible user categories: one SA, one or more HCAs, one or more CBAs, and one or more HHNs. The conformation process is followed as previously explained.

Likewise, a home health patient (or home health advocate) is contacted and asked to register by the HRA. Here, the HRA and collects the appropriate information for all possible user categories: only one (1) HHP per patient site and only one (1) HHPA per patient site. The confirmation process then takes place.

The HHCPO process is typically initiated when a patient is being discharged from a hospital and the attending physician has prescribed home health care for the patient. Once this occurs, the MD notifies the HDP and provides the necessary treatment. The HDP meets with the patient and perhaps with the patient's family to develop a cost effective care plan. The HDP will provide a list of possible HHAs to the patient to select the appropriate HHA. The HDP logs into the HHCPO system and initiates the necessary paperwork by creating the CPO (open-HDP). This goes to the HHA and not to the MD Inbox. Once the CPO has been completed, it is assigned to the appropriate MD for his review and approval (assigned-MD). The MD reviews the CPO and can send it back to the HDP for modifications (assigned-HDP) or approves the CPO (approved-MD). If the CPO need modification, the HDP will then make the suggested modifications and re-assign the CPO to the MD (assigned-MD). If the CPO is approved by the MD, it is automatically assigned to the HHA listed in the document (assigned-HHA).

The HHA reviews the CPO and either sends it back to the HDP for modifications (assigned-HDP), or approves it (approved-HRA). If the CPO requires modification, the HDP will make the suggested modifications and re-assign the CPO to the MD (assigned-MD). Usually CPOs go to MDs and not back to HDP. Once the CPO is approved by the HHA, the HHA will assign an HHN to the case. The CPO is now assigned-HHN.

The HHN will review and approve the CPO (approved-HHN).

As a CPO moves through the system, any user that is involved in the workflow process for a particular patient will always have access to REVIEW the form and check on the current status.

The HHCPO process can also be initiated when a patient has been prescribed home care from an MD practice. Patients are not admitted to the practice/office and so are not really discharged unlike in the hospital setting. Once the attending MD in the practice has determined that the patient will require home health care, the MD (or PA) completes a CPO to initiate the process. The MD (or PA) logs into the HHCPO system and creates the CPO (open-MD). Once the CPO has been completed, it is assigned to the appropriate HHA for his/her review and approval (assigned-HHA). The HHA reviews the CPO FORM and either sends it back to the MD for modifications (assigned-MD) or approves the CPO (approved-HRA). If the CPO requires modifications, the MD will then make the suggested changes and re-assign the CPO to the HHA (assigned-HHA). Once the CPO is approved by the HHA, the HHA will assign an HHN to the case (assigned-HHN). The HHN will review and approve the CPO (approved-HHN).

The HHCPO process can also be initiated when a HHN visits the patient in the home and determines that some additional treatment is required, or that a modification to the existing prescribed treatment is needed. This use case assumes the HHN has a laptop and access to the internet during the home visit. In this case, the HHN makes a visit to the patient and determines that additional treatment may be needed. The HHN can create the CPO form during the visit and assign it to the MD for approval (assigned-MD). The MD (or PA) will review the CPO and possibly make modifications or add comments. The MD will then approve the CPO (approved-MD). The HHN can then proceed with prescribed treatment.

The HHCPO process can also be initiated when a HHN visits the patient in the home and determines that some additional treatment is required, or that a modification to the existing prescribed treatment is needed. This use case assumes the HHN does NOT have a laptop, or has no access to the internet during the home visit. Under this scenario, the HHN starts the HHCPO process by contacting the HHA or by starting the process after returning to the office. Thus, the HHN makes a visit to the patient and determines that additional treatment may be needed; the HHN then calls the MD office to discuss the case; the MD (or PA) approves the change verbally; the HHN proceeds with prescribed treatment. This starts without the HHCPO process being complete. A CPO is generated documenting the change and is sent by the HHA or HHN to the MD/PA for approval.

The HHCPO process can also be initiated when a MD/PA determines that some additional treatment is required, or that a modification to the existing prescribed treatment is needed. Here, the MD determines a change is needed (due to patient visit to MD office or call from HHN); the MD (or PA) creates a new CPO or modifies and existing CPO makes a visit to the patient and determines that additional treatment may be needed; the HHN calls the MD office to discuss the case; the MD (or PA) creates the CPO form and approves the CPO (approved-MD); the HHN can proceed with prescribed treatment.

The HHCPO system also allows a patient (HHP) and/or patient advocate (HHPA) to configure courtesy email notification (or online notification) of any change in the order for a particular patient such as starting home care, a change in frequency, discontinuation of home care etc. This could be simply an email message as the notification or the message would include a link to the Login Page along with the notification that something has changed. No medical information will be provided in the email message. The email message is just notification for the patient (or advocate) to login to the HHCPO system to review any changes in status.

Patients (and patient advocates) are often very anxious about whether an agency has been notified or not—this could serve as reassurance. While Patient's email addresses would remain confidential, the notifications could have advertisements and clickable links (nutritional supplements and other products of that sort).

Many modifications and variations of the present invention are possible in light of the above teachings. It is, therefore, to be understood within the scope of the appended claims the invention may be protected otherwise than as specifically described.

What is claimed is:

1. A method of providing home healthcare to a patient, the method comprising the steps of:
providing a server in communication with a plurality of networks comprising a physician network, a home healthcare agency network and a hospital network;
serving unexecuted care plan oversight documents via the server between at least two of the physician, home healthcare agency and hospital networks;
receiving with the server executed care plan oversight documents from one of the plurality of networks;
using the server to associate executed and unexecuted care plan oversight documents and retaining the executed and unexecuted care plan documents according to a patient identifier on a database;
generating care plan oversight document templates and serving the templates to at least one of the plurality of networks; and
using the server to associate executed and unexecuted care plan oversight documents and retaining the executed and unexecuted care plan documents according to a provider identifier on a database.

2. The method of claim 1 further comprising the step of:
electronically changing a condition of a care plan oversight document between a set of conditions comprising an open condition, an assigned condition, an approved condition, a billed condition, and a paid condition.

3. A method of providing home healthcare to a patient, the method comprising the steps of:
providing a server for facilitating transactions between a plurality of networks comprising physician network, a home healthcare agency network and a hospital network;
using the server to provide unexecuted care plan oversight documents to one of the plurality of networks; and
using the server to receive executed care plan oversight documents categorizing care plan oversight documents for download from the server to one of the plurality of networks.

4. The method of claim 3 further comprising the step of:
providing means on the server for electronically signing the care plan oversight documents.

5. The method of claim 4 further comprising the step of:
using the server to generate care plan oversight document templates and serving the templates to at least one of the plurality of networks.

6. The method of claim 5 further comprising the step of:
using the server to associate executed and unexecuted care plan oversight documents and retaining the executed and unexecuted care plan documents according to a provider identifier on a database.

7. The method of claim 6 further comprising the step of:
using the server to provide a messaging system for communication between the plurality of networks.

8. The method of claim 7 further comprising the step of:
electronically changing a condition of a care plan oversight document between a set of conditions comprising an open condition, an assigned condition, an approved condition, a billed condition, and a paid condition

9. A system for managing home healthcare administration comprising:
a physician network comprising a plurality of physicians;
a home healthcare agency network comprising a plurality of home healthcare agencies in the business of providing in-home healthcare to patients;
a central server in communication with the physician, hospital and home healthcare agency networks for coordinating communications and data transferred between the physician, hospital, and home healthcare agency networks, the central server serving web-pages carrying care plan oversight data on electronic care plan oversight documents shared between the physician, hospital and home healthcare agency networks; and
means for electronically approving the electronic care plan oversight documents for carrying home health related tasks for a home health patient.

10. The system of claim 9 wherein the server provides a plurality of sites comprising a patient site, a home healthcare agency site, and a hospital site.

11. The system of claim 10 wherein the patient site is accessible by a patient registered to access the patient site.

12. The system of claim 11 wherein the patient site is accessible by a physician registered to access the hospital site.

13. The system of claim 12 wherein the patient site is accessible by a home healthcare agency professional registered to access the home healthcare agency site.

14. The system of claim 13 further comprising a database on the server for storing the electronic care plan oversight documents.

15. The system of claim 14 further comprising a means for generating reports associated with the electronic care plan oversight documents.

16. The system of claim 15 further comprising a messaging module on the server for serving communications between the physician and the home healthcare professional.
